(19) United States
(12) Patent Application Publication
(10) Pub. No.: US 2013/0129570 A1
(43) Pub. Date: May 23, 2013

(54) POLYCRYSTAL SILICON MANUFACTURING APPARATUS

(71) Applicant: SiliconValue LLC., Daejeon (KR)

(72) Inventors: Yun Sub Jung, Seoul (KR); Keun Ho Kim, Ulsan (KR); Yeo Kyun Yoon, Daejeon (KR); Ted Kim, Daejeon (KR)

(73) Assignee: SILICONVALUE LLC., Daejeon (KR)

(21) Appl. No.: 13/741,394

(22) Filed: Jan. 15, 2013

Related U.S. Application Data
(63) Continuation-in-part of application No. 13/247,587, filed on Sep. 28, 2011, now Pat. No. 8,377,208.

(30) Foreign Application Priority Data
Apr. 20, 2011 (KR) 10-2011-0036719

(51) Int. Cl. B01J 8/18

(52) U.S. Cl. CPC B01J 8/1809
USPC 422/119

(57) ABSTRACT

There is disclosed a polycrystal silicon manufacturing apparatus including a reaction pipe configured to provide a reaction space where seed silicon grows into polycrystal silicon, a flowing-gas supply unit configured to supply flowing gas to the seed silicon and the polycrystal silicon provided in the reaction pipe, a sensing unit configured to output level information based on the height of a fluidized bed which is changeable according to the growth of the polycrystal silicon, and a particle outlet configured to exhaust the polycrystal silicon formed in the reaction pipe outside, when the height of the fluidized bed corresponding to the level information is larger than an exhaustion start height of the fluidized bed corresponding to a start level.

### CROSS-REFERENCE TO RELATED APPLICATION

This application is a continuation-in-part of U.S. patent application Ser. No. 13/247,587, filed on Sep. 28, 2011, which claims priority from and the benefit of Korean Patent Application No. 10-2011-0036719, filed on Apr. 20, 2011, all of which are hereby incorporated by reference for all purposes as if fully set forth herein.

### BACKGROUND

1. Field

The present invention relates to a polycrystal silicon manufacturing apparatus.

2. Background

Generally, high purity polycrystal silicon has been used broadly for a semiconductor element that is useable for a semiconductor device or a solar cell, a chemical material that requires a high purity or an industrial element. Also, the high purity polycrystal silicon has been utilized for a precision functioned device or a precision part of a highly integrated micro system.

To fabricate such polycrystal silicon, silicon deposition has been used. According to the silicon deposition, silicon contained in reaction gas is constantly deposited by pyrolysis of reaction gas and hydrogen reaction.

However, for a serial operation of the fluidized bed reactor that is a good characteristic of the fluidized bed reactor, seed silicon filled into a fluidized bed has to grow to be a proper sized one that is able to be produced via deposition reaction. After that, a corresponding product has to be exhausted and the serial operation of the fluidized bed reactor may be enabled. In other words, a proper point for the silicon exhaustion may be set during the operation of the fluidized bed reactor. Different from that, silicon may be exhausted based on heuristics and productivity of silicon may be enhanced by a serial process. However, this method cannot be provided although it is recognized.

As a result, demands for a method of manufacturing polycrystal silicon particles serially and stably, with a high productivity and a low production price have increased.

### SUMMARY

Accordingly, the embodiments may be directed to a polycrystal silicon manufacturing apparatus. An object of the embodiments is to provide a polycrystal silicon manufacturing apparatus which is able to manufacture polycrystal silicon serially and stably.

Another object of the embodiments is to provide a polycrystal silicon manufacturing apparatus having enhanced productivity and a reduced production price.

To achieve these objects and other advantages and in accordance with the purpose of the embodiments, as embodied and broadly described herein, a polycrystal silicon manufacturing apparatus includes a reaction pipe configured to provide a reaction space where seed silicon grows into polycrystal silicon; a flowing-gas supply unit configured to supply flowing gas to the seed silicon and the polycrystal silicon provided in the reaction pipe; a sensing unit configured to output level information based on the height of a fluidized bed which is changeable according to the growth of the polycrystal silicon; and a particle outlet configured to exhaust the polycrystal silicon formed in the reaction pipe outside, when the height of the fluidized bed corresponding to the level information is larger than an exhaustion start height of the fluidized bed corresponding to a start level.

The sensing unit may include a distance sensor configured to sense a distance to the fluidized bed, which is changeable according to the growth of the polycrystal silicon, as the level information, and the particle outlet may exhaust the polycrystal silicon formed in the reaction pipe, when the distance between the distance sensor and the fluidized bed is an exhaustion start distance or less.

The distance sensor may be provided in opposite to the flowing gas supply unit to output a sensing signal toward the fluidized bed.

A window may be installed between the distance sensor and the reaction space to protect the distance sensor.

The particle outlet may exhaust the polycrystal silicon until the distance reaches an exhaustion stop distance.

The distance sensor may be provided to output a sensing signal toward an inner surface of the reaction pipe.

The polycrystal silicon manufacturing apparatus may further include an auxiliary distance sensor installed lower than the distance sensor, wherein the particle outlet may stop the exhaustion of the polycrystal silicon, when the distances sensed by the distance sensor and the auxiliary distance sensor, respectively are larger than the exhaustion start distance and an exhaustion stop distance, respectively.

The sensing unit may include a temperature sensor configured to sense a temperature inside the reaction pipe, which is changeable according to the growth of the polycrystal silicon, as the level information, and the particle outlet may exhaust the polycrystal silicon formed in the reaction pipe outside, when the temperature inside the reaction pipe sensed by the temperature sensor is an exhaustion start temperature or more.

A window may be installed between the temperature sensor and the reaction space to protect the temperature sensor.

The temperature sensor may sense the heat transmitted via a lateral surface of the reaction pipe or via a hole formed in the lateral surface.

The particle outlet may exhaust the polycrystal silicon, until the temperature sensed by the temperature sensor reaches an exhaustion stop temperature.

The polycrystal silicon manufacturing apparatus may further include an auxiliary temperature sensor installed lower than the temperature sensor, wherein the particle outlet may stop the exhaustion of the polycrystal silicon, when the temperatures sensed by the temperature sensor and the auxiliary temperature sensor, respectively are lower than the exhaustion start temperature and an exhaustion stop temperature, respectively.

The sensing unit may include a weight sensor configured to sense a weight of the polycrystal silicon manufacturing apparatus, which is changeable according to growth of the polycrystal silicon, as the level information, and the particle outlet exhausts the polycrystal silicon formed in the reaction pipe outside, when the weight of the polycrystal silicon manufacturing apparatus sensed by the weight sensor is an exhaustion start weight or more.

The particle outlet may exhaust the polycrystal silicon, until the weight sensed by the weight sensor reaches an exhaustion stop weight.

A support projected from an outer surface of the polycrystal silicon manufacturing apparatus may be supported by a supporting member installed outside the polycrystal silicon manufacturing apparatus, and the weight sensor may be positioned between the support and the support member.

The sensing unit may include a vibration sensor configured to output a frequency as the level information by sensing contact with the fluidized bed according to growth of the polycrystal silicon, and the particle outlet may exhaust the polycrystal silicon formed in the reaction pipe outside, when the frequency is an exhaustion start frequency or more.

The vibration sensor may be installed to pass through a lateral surface of the reaction pipe.

The vibration sensor may include a needle configured to contact with the fluidized bed, and the needle may be formed of an inorganic material capable of preventing contamination of the polycrystal silicon, or a lining formed of an inorganic material may be on a surface of the needle.

The particle outlet may exhaust the polycrystal silicon, until the frequency output by the vibration sensor reaches an exhaustion stop frequency.

The polycrystal silicon manufacturing may further include an auxiliary vibration sensor installed lower than the vibration sensor, wherein the particle outlet may stop the exhaustion of the polycrystal silicon, when the frequency and an auxiliary frequency output by the vibration sensor and the auxiliary vibration sensor, respectively are lower than the exhaustion start frequency and an exhaustion stop frequency, respectively.

As a result, the polycrystal silicon manufacturing apparatus according to the embodiments may include a control unit that is able to control a point of exhausting silicon particles automatically. Because of that, automation of polycrystal silicon production may be enabled.

Furthermore, according to the embodiments, mass production of polycrystal silicon may be enabled by the automation control and the production price may be lowered.

It is to be understood that both the foregoing general description and the following detailed description of the embodiments or arrangements are exemplary and explanatory and are intended to provide further explanation of the embodiments as claimed.

### BRIEF DESCRIPTION OF THE DRAWINGS

Arrangements and embodiments may be described in detail with reference to the following drawings in which like reference numerals refer to like elements and wherein:

FIG. 1 is a diagram schematically illustrating a polycrystal silicon manufacturing apparatus according to an exemplary embodiment;

FIG. 2 is a diagram illustrating an example of a plate provided in the polycrystal silicon manufacturing apparatus according to the embodiment;

FIG. 3 is a diagram illustrating another example of the plate provided in the polycrystal silicon manufacturing apparatus according to the embodiment; and

FIG. 4 is a diagram illustrating a method of exhausting silicon from the polycrystal silicon manufacturing apparatus according to the embodiment, based on an internal pressure;

FIGS. 5 to 7C are diagrams illustrating a method of exhausting silicon from the polycrystal silicon manufacturing apparatus according to the embodiment, based on the height of a fluidized bed;

FIGS. 8 to 9C are diagrams illustrating a method of exhausting silicon from the polycrystal silicon manufacturing apparatus according to the embodiment, based on the temperature of a the fluidized bed;

FIG. 10 is a diagram illustrating a method of exhausting silicon from the polycrystal silicon manufacturing apparatus according to the embodiment, based on the weight of the apparatus; and

FIGS. 11 to 12C are diagrams illustrating method of exhausting silicon from the polycrystal silicon manufacturing apparatus according to the embodiment, based on the frequency.

### DETAILED DESCRIPTION

Reference may now be made in detail to specific embodiments, examples of which may be illustrated in the accompanying drawings. Wherever possible, same reference numbers may be used throughout the drawings to refer to the same or like parts.

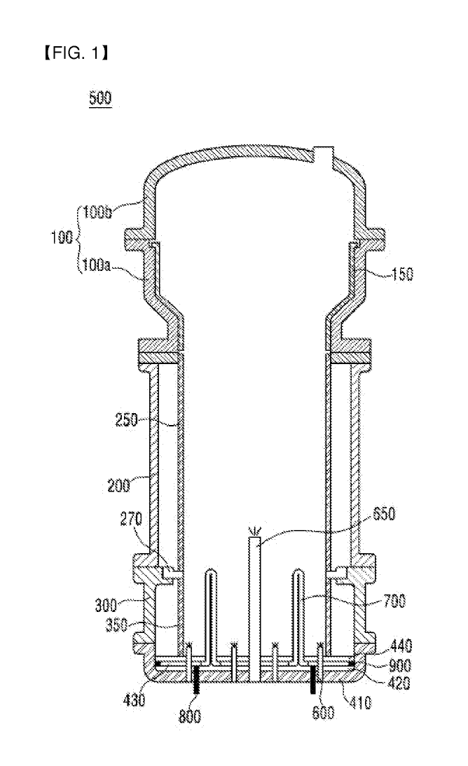

FIG. 1 illustrates a polycrystal silicon manufacturing apparatus according to an exemplary embodiment. As shown in FIG. 1, a polycrystal silicon manufacturing apparatus 500 according to an exemplary embodiment may include a head 100, a first body part 200, a second body part 300 and a bottom part 400.

The head 100 may be connected with the first body part 200 and it may have a larger diameter than a diameter of a first reaction pipe 250 provided in the first body part 200. When gas and microelements within the polycrystal silicon manufacturing apparatus 500 pass the head 100 from the first reaction pipe 250, the velocity of gas and microelements may decrease because of the larger diameter possessed by the head 100.

As a result, load of a post-process for the exhausted gas or microelements may be reduced. An inner wall of the head 100 may be formed of an inorganic material that will not be transformed at a high temperature. For example, the inner wall of the head 100 may be formed of at least one of quartz, silica, silicon nitride, boron nitride, zirconia, silicon carbide, graphite, silicon and vitreous carbon.

Also, at least one of coating or lining that uses an organic polymer may be performed to the inner wall of the head 100, if it is possible to cool an outer wall of the head 100.

When the inner wall of the head 100 is formed of a carbon containing material such as silicon carbide, graphite and vitreous carbon, polycrystal silicon may be contaminated by carbon impurities. Because of that, silicon, silica, quartz or silicon nitride may be coated or lined on the inner wall of the head 100 which could contact with the polyscrystal silicon.

For example, the head 100 may include a plurality of head parts 100a and 100b. A lining layer 150 may be located on an inner surface of the head part 100a.

The first body part 200 may be located under the head 100, connected with the head 100, and it may provide a predetermined space where polycrystal silicon deposition reaction may occur.

The second body part 300 may be located under the first body part 200, with connected with the first body part 200. Together with the first body part 200, the second body part 300 may provide a predetermined space where at least one of polycrystal silicon deposition reaction or heating reaction may occur.

Those first and second body parts 200 and 300 may be independently provided and they may be coupled to each other to provide a reaction space. Alternatively, the first and second body parts 200 and 300 may be integrally formed with each other.

The bottom part 400 may be located under the second body part 300, with connected with the second body part 300. A variety of nozzles 600 and 650, a heater 700 and an electrode 800 may be coupled to the bottom part 400 for the polycrystal silicon deposition.

In the meanwhile, the head 100, the first body part 200 and the second body part 300 may be formed of a proper metal material that is easy to treat with good mechanical strength and rigidity such as carbon steel, stainless steel and various steel alloys. A protection layer for the first and second body parts 200 and 300 formed of the material mentioned above may be formed of metal, organic polymer, ceramic or quartz.

When assembling the head 100, the first body part 200 and the second body part 300 to each other, a gasket or a sealing material may be used to shut off the inside of the reactor from external space. Each of the first and second body parts 200 and 300 may have a variety of shapes including a cylindrical pipe, a flange, a tube, a fitting, a plate, a corn, an oval or a jacket having a cooling medium flowing between double-framed walls.

Also, when the head 100, the first body part 200 and the second body part 300 are formed of the metal material, a protection layer may be coated on an inner surface possessed by each of them or a protection pipe or a protection wall may be installed additionally. The protection layer, pipe or wall may be formed of a metal material. However, a non-metal material such as organic polymer, ceramic and quartz may be coated or lined on the protection layer, pipe or wall to prevent contamination inside the reactor.

The first and second body parts 200 and 300 may be maintained blow a predetermined range of temperatures by cooling fluid such as water, oil, gas and air, to prevent heat expansion, to protect workers and to prevent accidents. Inner or outer walls of components provided in the first and second body parts 200 and 300 that need cooling may be fabricated to allow the cooling fluid to circulate there through.

In the meanwhile, an insulator may be arranged on an outer surface of each of the first and second body parts 200 and 300 to protect workers and to prevent too much heat loss.

As follows, a process of assembling a polycrystal silicon manufacturing apparatus according to an embodiment will be described.

A first reaction pipe 250 may be assembled to be located inside the first body part 200 and a second reaction pipe 350 may be assembled to be located inside the second body part 300. Various nozzles 600 and 650, an electrode 800 and a heater 700 are assembled to the bottom part 400 configured to close a bottom of the second body part 300 airtight. The bottom part 400 may be connected with a lower area of the second body part 300 having the second reaction pipe 350 provided therein. After that, the first body part 200 and the second body part 300 may be connected with each other and the head 100 may be connected with the first body part 200.

Various gas supply units assembled to the bottom part 400 may include a flowing-gas supply unit 600 and a reaction gas supply unit 650.

The first and second reaction pipes 250 and 350 may be tube-shaped or partially tube-shaped, corn-shaped and oval-shaped. Each end of the first and second reaction pipes 250 and 350 may be processed to be a flange type. The first and second reaction pipes 250 and 350 may be configured of a plurality of parts and some of the parts may be arranged on inner walls of the first and second body parts 200 and 300 as liners.

The first and second reaction pipes 250 and 350 may be formed of an inorganic material that is not transformed easily at a high temperature. The inorganic material may be quartz, silica, silicon nitride, boron nitride, zirconia, yttria, silicon carbide, graphite, silicon, vitreous carbon and a compound of them.

When the first and second reaction pipes 250 and 350 are formed of a carbon containing material such as silicon carbide, graphite, vitreous carbon and the like, the carbon containing material might contaminate the polycrystal silicon. Because of that, silicon, silica, quartz, silicon nitride and the like may be coated or lined on each inner wall of the first and second reaction pipes that can contact with the polycrystal silicon.

The flowing-gas supply unit 600 may be configured to supply flowing-gas that enables silicon particles to flow within the reaction pipe. Some or all of the silicon particles may flow with the flowing-gas. At this time, the flowing-gas may include at least one of hydrogen, nitrogen, argon, helium, hydrogen chloride (HCl), silicon tetra chloride (SiCl₄). The flowing-gas supply unit 600 may be a tub, a liner or a molded material.

The reaction gas supply unit 650 may be configured to supply reaction gas that containing silicon elements to a silicon particle layer. The reaction gas is raw material gas that is used in deposition of polycrystal silicon and it may include silicon elements. The reaction gas may include at least one of monosilan (SiH₄), disilane (Si₆H₆), higher-silane (SiₙH₂ₙ₊₂, ‘n’ is a 3 or more a natural number), dichlide silane (SCS: SiH₂Cl₂), trichlide silane (TCS: SiHCl₃), tetra chlide silane (STC: SiCl₄), dibromosilane (SiH₂Br₂), tribromo silane (SiHBr₃), silicontetrabromide (SiBr₄), diiodosilane (SiH₂I₂), triiodosilane (SiHI₃) and silicontetraiodide (SiI₄). At this time, the reaction gas may further include at least one of hydrogen, nitrogen, argon, helium or hydrogen chloride. As the reaction gas is supplied, polycrystal silicon is deposited on a surface of a seed crystal having a size of 0.1 to 2 mm and the size of the polycrystal silicon may be increased.

When the size of the polycrystal silicon is increased up to a preset value, the reaction gas may be exhausted outside the polycrystal silicon manufacturing apparatus. The heater 700 may supply heat that is used for generating silicon deposition reaction on the surface of the polycrystal silicon within the polycrystal silicon manufacturing apparatus.

According to the embodiment, the heat used for the silicon deposition reaction may be generated in the reaction pipe. Alternatively, the heat generated outside the reaction pipe 250 may be supplied to the inside of the reaction pipe 250 and the heat may be used for the silicon deposition reaction. The heater 700 may include a resistant to be supplied electricity, to generate and supply the heat. The heater 700 may include at least one of graphite, ceramic such as and a metal material.

A gas outlet may be arranged in the head 100 to exhaust exhaustion gas including the flowing gas, non-reaction gas, reaction generation gas outside. Here, the gas outlet may be operated serially. Minute silicon particles or high molecular reaction by-product transported by the exhaustion gas may be separated in an auxiliary exhaustion processing unit (not shown).

The gas supply units 600 and 650, that is, various nozzles, the electrode 800 and the heater 700 may be assembled to the bottom part 400, together with plates 410 to 440 composing the bottom part 400. As shown in the drawings, the bottom part 400 according to the embodiment may include a lower plate 410 and first to third plates 420, 430 and 440.

The lower plate 410 may be connected with the second body part 300 and it may be assembled to the flowing-gas supply unit and the reaction gas supply unit. The lower plate 410 may be formed of a metal material that is easy and efficient to process, with an excellent mechanical strength and rigidity, such as carbon steel, stainless steel and alloy steel.

The first plate 420 may be located on the lower plate 410, to insulate the lower plate 410. Because of that, the first plate 420 may be formed of a proper material that may be resistant against a high temperature, without contaminating the deposited polycrystal silicon and even with an insulation property, such as quartz. The first plate 420 may be formed of a ceramic material such as silicon nitride, alumina and yttria, rather than quartz. If necessary, such a ceramic material may be coated or lined on a surface of the first plate 420.

The second plate 430 may be located on the first plate 420 and it may be in contact with the heater 700 to supply electricity to the heater 700. Because of that, the second plate 430 may be formed of a conductive material such as graphite, graphite having silicon carbide coated thereon, silicon carbide and graphite having silicon nitride coated thereon. The first plate 420 having the insulation property may be located between the lower plate 410 and the second plate 430, such that the lower plate 410 may be insulated from the second plate 430. The second plate 430 may be in contact with the heater 700 and heat may be generated from the second plate 430. However, the second plate 430 may have a relatively large sectional area where electric currents flow, compared with a sectional area of the heater where electric currents flow. Because of that, the heat generated in the second plate 430 may be much smaller than the heat generated in the heater 700. Also, to reduce the heat generated in the second plate 430, a graphite sheet may be insertedly disposed between the second plate 430 and the heater 700.

When the lower plate 410 and the second plate 430 have conductivity, a leakage current might be generated by the contact between the lower plate 410 and the second plate 430 and the leakage current might flow to the lower plate 410. Because of that, an end of the lower plate 410 may be spaced apart a proper distance from an end of the second plate 430 as shown in the drawings.

In other words, a recess may be formed in the first plate 420 and the second plate 430 may be seated in the recess. For example, a recess having an identical to or larger length as the length of the second plate 430 may be formed in the first plate 420 and the second plate may be seated in the recess of the first plate 420. As a result, a proper area of the first plate 420 may be positioned between the lower plate 410 and the end of the second plate 430, to maintain the insulation between the lower plate 410 and the second plate 430.

As shown in the drawings, the lower plate 410 and the second plate 430 may be insulated from each other by the first plate 420. Alternatively, an insulation ring 900 may be arranged around a rim of the second plate 430, to insulate the lower plate 410 from the second plate 430. At this time, the insulation ring 900 may be formed of quartz and ceramic.

The third plate 440 may be located on the second plate 430 to prevent the polycrystal silicon deposited from the first and second reaction pipes 250 and 350 from being contaminated from the second plate 430, with an insulation property. Because of that, the third plate 440 may be formed of an inorganic material that may not be transformed at a high temperature, namely, high-temperature-resist. The inorganic material may be quartz, silica, silicon nitride, boron nitride, zirconia, silicon carbide, graphite, silicon, vitreous carbide or a compound of them. When the third plate 440 is formed of the carbon containing material such as silicon carbide, graphite and vitreous carbon, the carbon containing material might contaminate the polycrystal silicon. Silicon, silica, quartz, silicon nitride and the like may be coated or lined on a surface of the third plate 440.

Also, each of the second plate and the third plates 440 composing the bottom part 400 may include a plurality of unit-plates, not as a single body. Because of that, the assembly, installation and maintenance of the polycrystal silicon manufacturing apparatus may be more smooth and efficient. In other words, the size of the polycrystal silicon manufacturing apparatus is increased for the mass production of polycrystal silicon. When each of the second and third plates 430 and 440 is formed as a single body, the assembly, installation and maintenance of the polycrystal silicon manufacturing apparatus may be difficult.

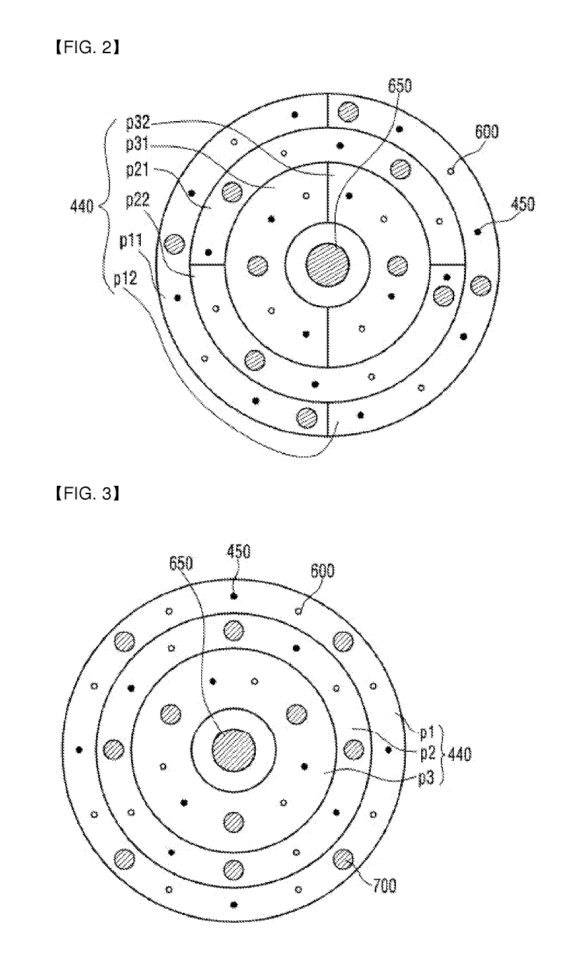

For example, as shown in FIG. 2, the third plate 440 may be configured of pieces cut away along concentric and diameter directions with respect to the third plate 440. As shown in FIG. 3, the third plate 440 may be configured of ring-shaped pieces having different sizes.

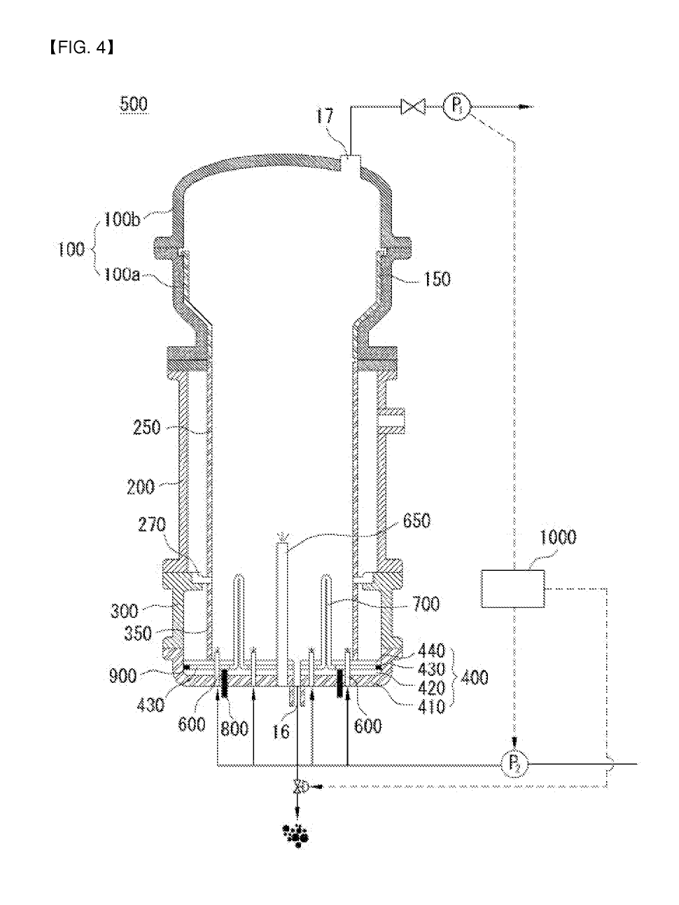

FIG. 4 is a diagram illustrating a method of exhausting silicon from the polycrystal silicon manufacturing apparatus according to the embodiment, based on an internal pressure.

The same description as already described above in the structure of the polycrystal silicon manufacturing apparatus in reference to FIG. 1 will be omitted. As shown in FIG. 4, the polycrystal silicon manufacturing apparatus 500 may include a particle outlet 16 arranged under the reaction pipe to exhaust polycrystal silicon particles generated after the silicon deposition reaction.

The particle outlet 16 may be assembled together with the reaction gas supply unit 650 or it may be assembled independent from the reaction gas supply unit 650. Such the particle outlet may enable the silicon particles exhausted from the reaction space serially, periodically or intermittently at a required time point.

At this time, the silicon particles may be cooled while they are exhausted via the particle outlet 16. Because of that, predetermined gas such as hydrogen, nitrogen, argon and helium may flow via the particle outlet 16. Alternatively, water, oil, gas or refrigerant may be circulated along a wall surface of the particle outlet 16, to cool hot silicon particles.

In the meanwhile, it is required to prevent the silicon particles from contaminated by impurities while they are exhausted out of the reactor via the particle outlet 16. Because of that, some elements composing the particle outlet that are configured to contact with high temperature silicon product particles may be tubes, liners or molded-materials formed of an inorganic material that is useable in the reaction pipe.

An internal pressure of the polycrystal silicon manufacturing apparatus has much difference in internal areas according to growth of polycrystal silicon particles. Because of that, according to the embodiment, silicon particles may be manufactured by automatically controlling a difference of pressures at the internal areas.

For example, in the polycrystal silicon manufacturing apparatus, pressures at first and second areas provided in the internal area of the reaction pipes 250 and 350 may be measured. The polycrystal silicon manufacturing apparatus may be automatically or manually controlled based on a difference of the two pressures.

The first area possessed by the internal area of the reaction pipes may be an area that receives gas from the nozzle connected to the outside from a lower portion of the reaction pipe, for example, either of a reaction gas supply part 15 and the flowing-gas supply part 14.

A first pressure sensor (P2) may be installed in at least one of the reaction gas supply part 15 and the flowing-gas supply part 14, to measure a corresponding pressure. For example, the first pressure sensor (P2) may be mounted in one of the plurality of the flowing-gas supply parts, to measure a corresponding pressure. Flowing gas may be supplied via the other flowing-gas supply parts.

The internal pressure of the reaction pipes may be measured by the first pressure sensor. The first pressure sensor may be mounted according to the installation structure of the conventional reactor conveniently.

A second pressure sensor (P1) may be installed in the gas outlet 17, to measure the pressure of the second area out of the internal areas of the reaction pipes.

According to this embodiment, the first pressure sensor (P2) may be installed in either of the reaction gas supply unit 650 and the flowing-gas supply unit 600. However, the first pressure sensor (P2) may be installed in any places where a lower pressure of the silicon particle fluidized bed, that is, the pressure of the first area provided in the internal area can be measured. The first area may be an area where a maximum pressure may be measured in the internal area of the silicon particle fluidized bed.

Similarly, the second pressure sensor (P1) may be installed at any places where an upper pressure of the silicon fluidized bed, that is, the pressure of the internal area can be measured. The second area may be an area where a minimum pressure can be measured in the internal area of the silicon particle fluidized bed.

A control unit 1000 may be connected with an internal area 4 via the flowing-gas supply unit 600, the reaction gas supply unit 650 or the gas outlet 17 that are exhausted to the internal area directly or indirectly.

The control unit 1000 may selectively include at least one of a connection pipe required for connection, a fitting part, a manual, semi-automatic or automatic type valve, a digital or analog type pressure or differential pressure gauge and a signal converter or controller having a computing function.

Also, the control unit 1000 may be connected mechanically or in signal circuit, and it may be partially or combinationally connected with control means such as a central control system, a distributed control system (DCS), a local control system.

When reaction gas is supplied to the internal space of the reaction pipe via the reaction gas supply unit 650, silicon elements may be deposited from a surface of seed silicon filled into the reaction space and silicon may be manufactured from such the polycrystal silicon manufacturing apparatus.

In a silicon particle manufacturing step, a layer of silicon particles may be formed on first and second reaction pipe areas. The silicon particles located on the two areas may be mixed with each other, with silicon particles located in at least first reaction area maintaining a status of flowing.

The flow of the silicon particles may refer that a spatial space of silicon particles is changed by flow of gas, movement of gas bubbles and/or movement of surrounding particles with time.

Here, flowing gas may be supplied to a top area of at least the first reaction area to make the particles flow to exchange the silicon particles between the two reaction areas.

With the manufacturing of the polycrystal silicon particles, the polycrystal silicon particles may accumulate in the reaction space and the internal pressure of the reaction pipe may be increased. As a result, a difference between the internal pressure of the first area measured by the first pressure sensor (P2) and the internal pressure of the second area measured by the second pressure sensor (P1) may be increased. At this time, the control unit 1000 may determine whether the difference between the internal pressures is increased to reach a preset first reference value.

The first reference value may be changeable based on an internal environment and the structure of the silicon manufacturing apparatus or it may be set differently based on the areas measured by the first and second pressure sensors.

This is because the internal pressure measured after the silicon deposition reaction can be different according to the structure or internal environment of the silicon manufacturing apparatus. Also, even when the internal environment and structure of the polycrystal silicon manufacturing apparatus is fixed, the internal pressure measured after the silicon deposition reaction may be different according to the measurement positions of the pressure sensors. When the control unit 1000 determines that the difference between the internal pressures reaches the first reference value, the polycrystal silicon particle outlet may be open and the silicon particles may be partially exhausted. The polycrystal silicon particle outlet may be automatically or manually operated.

As the polycrystal silicon particles are exhausted, the height of the silicon fluidized bed may be decreased again and the difference between the internal pressures may be then decreased. Hence, when determining that the difference between the internal pressures reaches a preset second reference value, the control unit 1000 may close the polycrystal silicon particle outlet and it may prevent polycrystal silicon particles from being exhausted any further. Here, the particle outlet may be operated manually or automatically.

Such the operation may enable the exhaustion of the polycrystal silicon particles, which is performed in the conventional manufacturing of the polycrystal silicon particles as checked with naked eyes, to be automatically performed by the control of the control unit 1000.

In the meanwhile, according to the embodiment, the difference between the internal pressures are measured by the first and second pressure sensors and the measured difference may be compared with the reference values, to determine the opening and closing of the polycrystal silicon particle outlet based on the result of the comparison. Alternatively, a pressure sensor may be mounted in the gas outlet or the flowing-gas supply unit and only the pressure measured by the pressure sensor in the gas outlet or the flowing-gas supply unit may be compared with a reference pressure value. At this time, when the measured pressure is the reference pressure value or more, the polycrystal silicon particles may be controlled to be exhausted via the polycrystal silicon particle outlet formed in the reaction pipe.

At this time, the reference pressure value may be variable according to an operation pressure. Here, the operation pressure may be a pressure preset to operate the polycrystal silicon manufacturing apparatus stably.

For example, when the operation pressure is 2.0 bar (gauge pressure), the reference pressure value may be 3.5 bar (gauge pressure). In case of 4 bar (gauge pressure), the reference pressure value may be 5.5 bar (gauge pressure). In other words, the particle outlet may be controlled to be open, when a reference pressure value with respect to the operation pressure is 0.5 bar or more (gauge pressure).

According to the embodiment, the reference pressure value with respect to the operation pressure is 0.5 bar or more and it may be lowered.

Therefore, the reference pressure value may not be limited to a specific value and it may be variable according to the internal environment or structure of the polycrystal silicon manufacturing apparatus. Because of that, the reference pressure value with respect to the operation pressure may be variable.

In the meanwhile, the difference between the pressures in the reaction space or the reference value of the flowing gas supply pressure may be determined based on the size of the growing silicon particle, and the production and exhaustion time point of the polycrystal silicon particle may be adjusted by controlling the size of the silicon particle.

Also, the size of the silicon particle may be differentiated by one of the number of the seed silicons, the concentration of the reaction gas, the reaction temperature, the reaction pressure and the quantity of the flowing gas.

The embodiment discloses the factors that affect the size of the silicon particle. However, the silicon particle size may be differentiated by internal environments and other conditions of the polycrystal silicon manufacturing apparatus, rather than the factors mentioned above.

In the embodiment shown FIGS. 1 to 4, the different numeral references are given to the first reaction pipe and the second reaction pipe, respectively. However, in a following embodiment, one numeral reference is given to the first and second reaction pipes. A polycrystal silicon manufacturing apparatus according to this embodiment which will be described may include a first body part 200 and a second body part 300, and a plurality of reaction pipes 905 or one reaction pipe 905 detachably arranged in the first and second body parts 200 and 300.

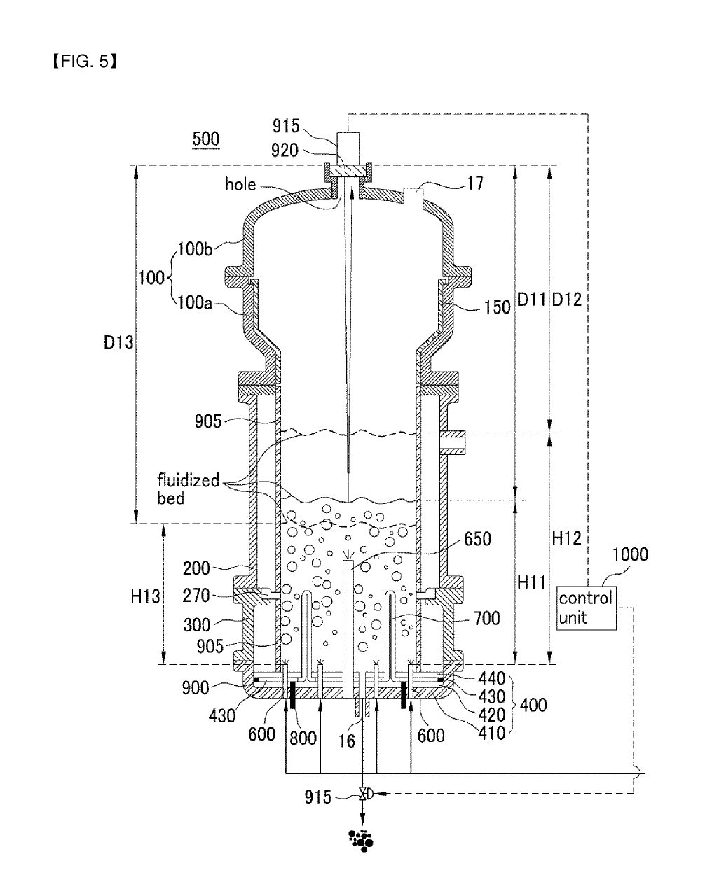

FIGS. 5 to 12C illustrate the polycrystal silicon manufacturing apparatus according to this embodiment. The polycrystal silicon manufacturing apparatus includes a reaction pipe 905, a flowing-gas supply unit 600, a sector unit 915, 925, 930, 935, 940, 960 and 965 and a particle outlet 16.

The reaction pipe 905 is configured to provide a reaction space where seed silicon grows into polycrystal silicon.

The flowing gas supply part 600 supplies flowing gas to the seed silicon and the polycrystal silicon provided in the reaction pipe 905.

The sensing unit 915, 925, 930, 935, 940, 960 and 965 may output level information based on the height of the fluidized bed which is changeable according to the growth of the polycrystal silicon. The sensing unit 915, 925, 930, 935, 940, 960 and 965 may include a distance sensor 915, a temperature sensor 930, a weight sensor 940 and a vibration sensor 960.

When it includes a distance sensor 915, the polycrystal silicon manufacturing apparatus according to this embodiment may further include an auxiliary distance sensor 925.

When it includes a temperature sensor 935, the polycrystal silicon manufacturing apparatus according to this embodiment may further include an auxiliary temperature sensor 935.

When it includes a vibration sensor 960, the polycrystal silicon manufacturing apparatus according to this embodiment may further include an auxiliary vibration sensor.

Such the sensing unit 915, 925, 930, 935, 940, 960 and 965 will be described in detail later, referring to corresponding drawings.

The particle outlet 16 is configured to exhaust the polycrystal silicon formed in the reaction pipe 905 outside, when the height of the fluidized bed corresponding to the level information is larger than the height of the fluidized bed in when the silicon exhaustion starts (hereinafter, the exhaustion start height).

FIGS. 5 to 7C are diagrams illustrating a method of exhausting silicon from the polycrystal silicon manufacturing apparatus according to the embodiment, based on the height of a fluidized bed.

As the flowing gas is getting injected, the seed silicon and the polycrystal silicon are flowing and the fluidized bed is formed in this process. When the flowing gas and the reacting gas are supplied to the reaction space, the seed silicon grows into the polycrystal silicon. As the polycrystal silicon grows, the height of the fluidized bed increases. Accordingly, this embodiment may automatically control the exhaustion of the polycrystal silicon based on the change in the heights of the fluidized bed.

For that, the polycrystal silicon manufacturing apparatus according to this embodiment may include a reaction pipe 905, a flowing gas supply unit 600, a distance sensor 910 and a particle outlet 16.

The reaction pipe 905 is configured to provide a reaction space where seed silicon grows into polycrystal silicon.

The flowing gas supply part 600 supplies flowing gas to the seed silicon and the polycrystal silicon provided in the reaction pipe 905.

The distance sensor 910 senses as a level information a distance to the fluidized bed changeable according to the growth of the polycrystal silicon.

The distance sensor 910 may output the distance to the fluidized bed from the distance sensor 910, using a difference between the time when an ultrasonic wave or laser is output and the time taken for the ultrasonic wave or laser to be reflected on the fluidized bed and to be incident on the distance sensor 910. At this time, the ultrasonic wave or the laser may be reflected on the particle of the fluidized bed (in other words, seed silicon and polycrystal silicon).

The distance 910 provided in the polycrystal silicon manufacturing apparatus according to this embodiment is not limited to what is mentioned above and various types of distance sensors that are able to sense the distance between to the fluidized bed there from may be applied.

The particle outlet 16 is configured to exhaust the polycrystal silicon formed in the reaction pipe 905 outside, in case the distance between the distance sensor 910 and the fluidized bed is an exhaustion start distance or less.

As the seed silicon is growing into the polycrystal silicon, the height of the fluidized bed may be increased. Accordingly, the distance between the distance sensor 910 and the fluidized bed is smaller than D11 and the distance sensor 910 outputs the distance between the distance sensor 910 and the fluidized bed.

The height of the fluidized bed is measured, using an end of the flowing gas supply unit as a reference, and this is one of examples. Various references may be set and such various references include one surface of a third plate 430 exposed to the reaction space.

A control unit 1000 may receive the distances between the distance sensor 910 and the fluidized distance from the distance sensor 910 and compare the input distance with an exhaustion start distance. When the height of the fluidized bed increased by the growth of the polycrystal silicon is H12, the distance between the distance sensor 910 and the fluidized bed is gradually decreased to be the exhaustion start distance (D12) or smaller. At this time, the height of the fluidized bed (H12) is corresponding to the exhaustion start height.

When the distance between the distance sensor 910 and the fluidized bed is the exhaustion start distance (D12) or less, the control unit 1000 may output a control signal and controls the particle outlet 16 to exhaust the polycrystal silicon based on the control signal. For example, the control unit 1000 may output the control signal to a valve 915 installed in the particle outlet 16. When the valve 915 is open according to the control signal, the polycrystal silicon may be exhausted via the particle outlet 16.

As the polycrystal silicon is exhausted, the height of the fluidized bed is lowered down to H13 and the distance between the distance sensor 910 and the fluidized bed is increased. At this time, the particle outlet 16 may exhaust the polycrystal silicon until the distance between the distance sensor 910 and the fluidized bed reaches an exhaustion stop distance (D13).

When the distance between the distance sensor 910 and the fluidized bed, which is input from the distance sensor 910, reaches the exhaustion stop distance (D13), the control unit 1000 may output the control signal to close the valve 915. The valve 915 is closed according to the control signal of the control unit 1000 and the exhaustion of the polycrystal silicon may stop.

Meanwhile, a window 920 may be installed between the distance sensor 910 and the reaction space to protect the distance sensor 910. The movement of the particle within the reaction pipe 905 is enlarged by the flowing gas such that the flowing particle can collide against the distance sensor 910 to cause an error or damage to the distance sensor 910.

The window 920 may be installed between the distance sensor 910 and the reaction space and protect the distance sensor 910 from the flowing seed silicon or polycrystal silicon. In addition, an operator of the polycrystal silicon manufacturing apparatus may check an inner state or the height of the fluidized bed via the window 920.

The window may be formed of a transparent inorganic material that is not subject to deformation at a high temperature, with allowing a sensing signal output from the distance sensor 910 to transmit there through, to protect such the seed silicon or polycrystal silicon colliding against the window.

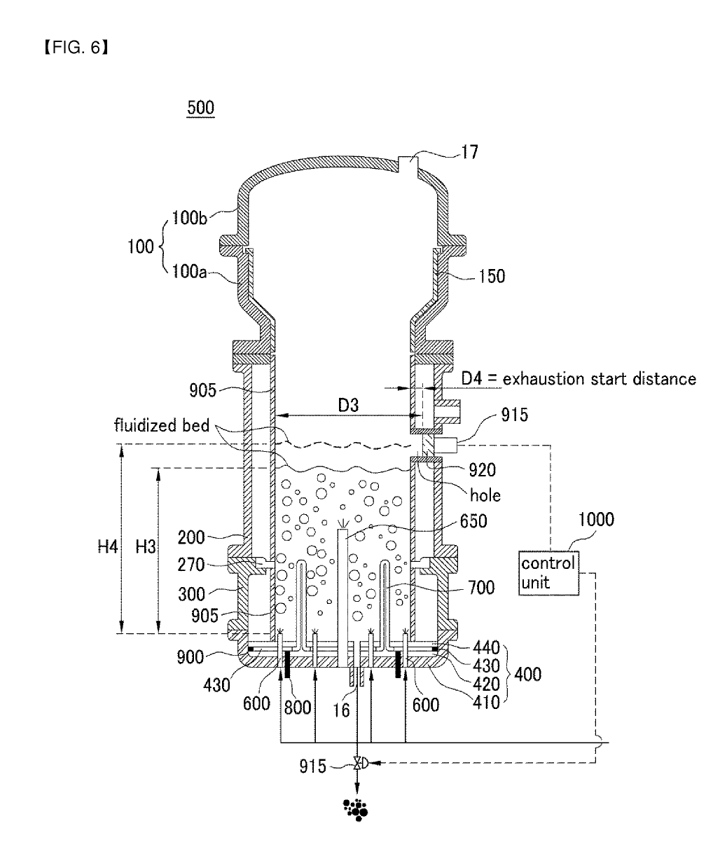

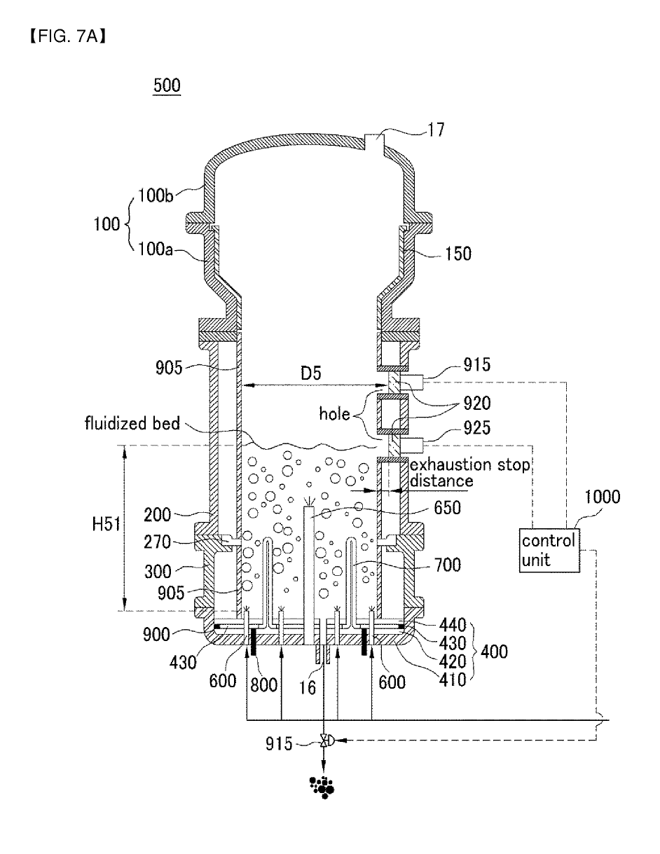

The window 920 may be insertedly secured to a hole formed in the head part 100b provided in the polycrystal silicon manufacturing apparatus of FIG. 5. As shown in FIG. 5, the window 920 may be provided in opposite to the flowing gas supply unit 600, to output the sensing signal toward the fluidized bed. Optionally, as shown in FIG. 6, the distance sensor 910 may be provided to output the sensing signal toward an inner surface of the reaction pipe 905.

A hole is formed in a lateral surface of the reaction pipe 905 to make the reaction space communicate with the outside of the polycrystal silicon manufacturing apparatus and the window 920 may be inserted in the hole to protect the distance sensor 910. The distance sensor 910 may be provided in opposite to the reaction space with respect to the window 920.

As the polycrystal silicon is growing, the height of the fluidized bed is increasing. When the height of the fluidized bed is H3, the fluidized bed is not positioned in front of the distance sensor 910 and the distance sensed by the distance sensor 910 may be a distance (D3) to the inner surface of the reaction pipe 905 from the distance sensor 910.

When the height of the fluidized bed is H4 after the continuous growth of the polycrystal silicon, the fluidized bed is positioned in front of the distance sensor 910 and the height (H4) of the fluidized bed may be corresponding to the exhaustion stating height. Accordingly, the distance sensed by the distance sensor 910 may be a distance (D4) to the fluidized bed from the distance sensor 910.

When the fluidized bed is positioned in front of the distance sensor 910, the distance (D4) between the distance sensor 910 and the fluidized bed may be set as an exhaustion start distance. As mentioned above, the particle outlet 16 may exhaust the polycrystal silicon formed in the reaction pipe 905 outside, when the distance between the distance sensor 910 and the fluidized bed is the exhaustion start distance or less. For that, the control unit 1000 may output the control signal and the valve 915 is open according to the control signal to exhaust the polycrystal silicon.

Once the polycrystal silicon is exhausted, the height of the fluidized bed is lowered and the distance between the distance sensor 910 and the fluidized bed is more than the exhaustion start distance. Accordingly, the control unit 1000 may output a control signal to close the valve 915. As the valve 915 is closed, the exhaustion of polycrystal silicon is stopped.

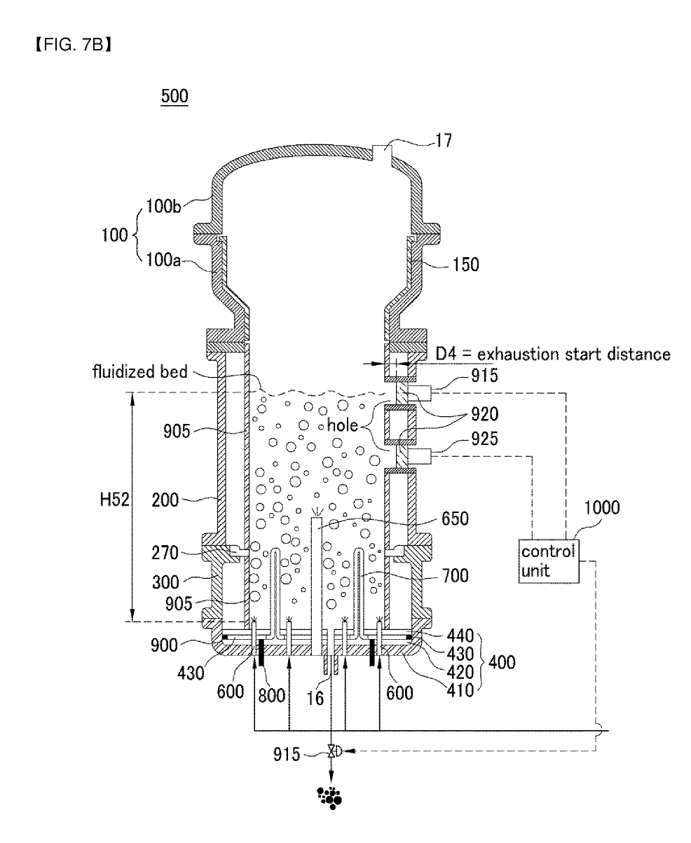

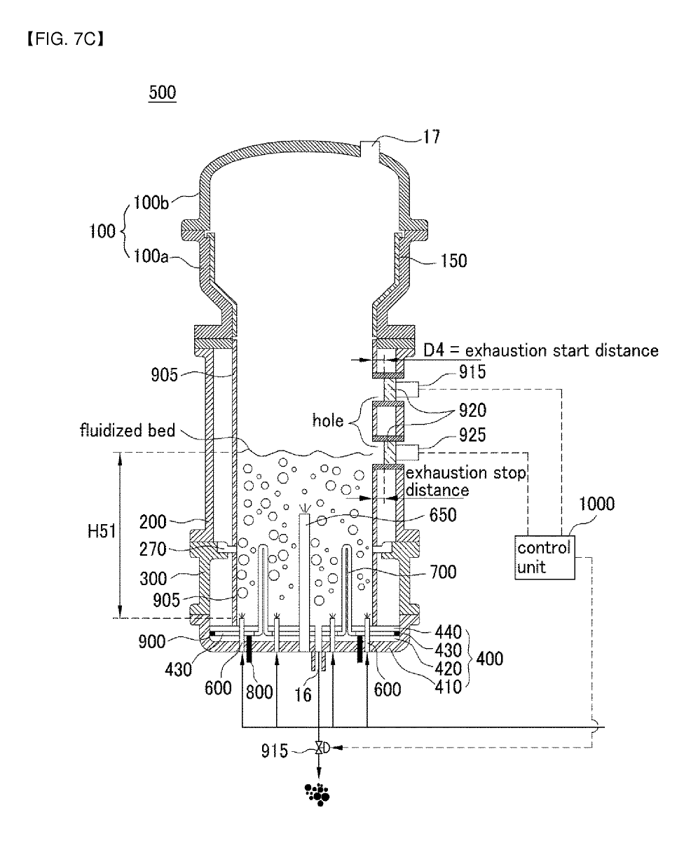

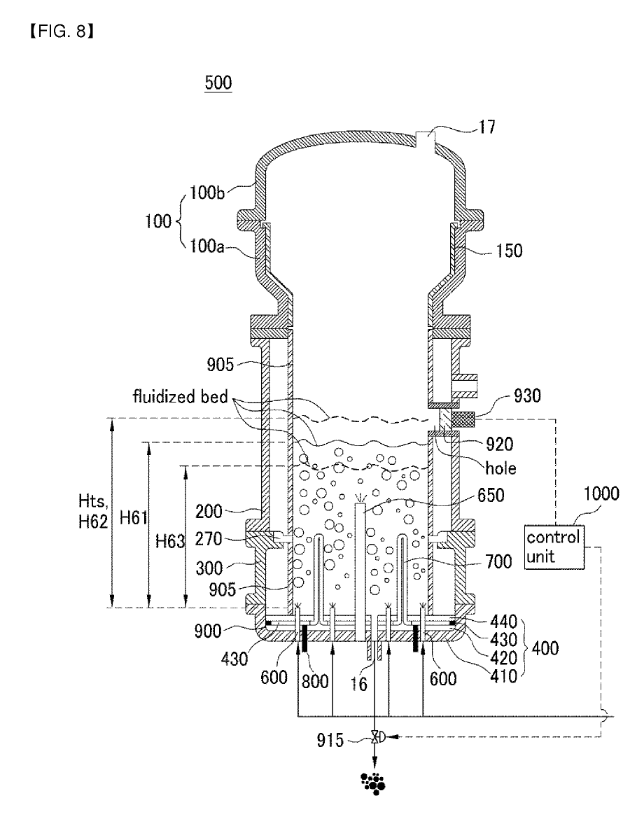

As shown in FIGS. 7A to 7C, the polycrystal silicon manufacturing apparatus according to this embodiment may further include an auxiliary distance sensor 925 installed lower than the distance sensor 910. The window 920 may be installed between the auxiliary distance sensor 925 and the reaction space. At this time, a hole is formed in a lateral surface of the reaction pipe 905 to make the reaction space communicate with the outside of the polycrystal silicon manufacturing apparatus and the window 920 for protecting the auxiliary distance sensor may be inserted in the hole.

As shown in FIG. 7A, the height of the fluidized bed rises up to a height (H51) by the growth of the polycrystal silicon and the fluidized bed may be positioned in front of the auxiliary distance sensor 925. Accordingly, the distance between the auxiliary distance sensor 925 and the fluidized bed may be the exhaustion stop distance or less. In addition, the fluidized bed may not reach an area in front of the distance sensor 910 such that the distance sensed by the distance sensor 910 may be a distance (D5) to an inner surface of the reaction pipe 905 from the distance sensor 910.

As shown in FIG. 7B, the height of the polycrystal silicon is continuously growing and the fluidized bed can rise up to H52 such that the fluidized bed can be positioned in front of the distance sensor 910. As the distance between the distance sensor 910 and the fluidized bed is the exhaustion start distance or less, the particle outlet 16 starts to exhaust the polycrystal silicon. At this time, the height (H52) of the fluidized bed is corresponding to the exhaustion start height.

The height of the fluidized bed is lowered by the exhaustion of the polycrystal silicon and the fluidized bed passes in front of the auxiliary distance sensor 925. After that, the distances sensed by the distance sensor 910 and the auxiliary distance sensor 925 can be larger than the exhaustion start distance and the exhaustion stop distance, respectively. The particle outlet 16 can stop the exhaustion of polycrystal silicon.

The control unit 1000 may a control signal to close the valve 915, when the distances input from the distance sensor 910 and the auxiliary sensor 925 are larger than the exhaustion start distance and the exhaustion stop distance, respectively. The valve 915 is closed according to the control signal and the exhaustion of polycrystal is stopped.

In FIGS. 6 to 7C, the exhaustion start distance may be smaller than the distance between the distance sensor 910 and the inner surface of the reaction pipe 905 in opposite to the distance sensor 910. In FIGS. 7A to 7C, the exhaustion stop distance may be smaller than the distance between the auxiliary distance sensor 925 and the inner surface of the reaction pipe 905 in opposite to the auxiliary distance sensor 925. The exhaustion start distance may be identical to or different from the exhaustion stop distance.

FIG. 8 is a diagram illustrating a method of exhausting silicon from the polycrystal silicon manufacturing apparatus according to the embodiment, based on the temperature inside the fluidized bed. As shown in FIG. 8, the polycrystal silicon manufacturing apparatus according to this embodiment may include a temperature sensor 930.

At this time, a window 920 may be provided between the temperature sensor 930 and the reaction space to protect the temperature sensor 930. The functions and material of the window 920 are described in the embodiment mentioned above and detailed description thereof will be omitted accordingly.

The temperature sensor 930 may sense temperature inside the reaction pipe 905, which is changeable according to the growth of the polycrystal silicon, as a level information.

At this time, the temperature sensor 930 may sense the temperature at a preset sensing temperature that can be the height (Hts) when the temperature sensor 930 is installed.

In FIG. 8, the sensing height is measured with respect to an end of the flowing gas supply unit 600 and that is one of examples. Various references including one surface of the third plate 430 exposed to the reaction space may be set.

The particle outlet 16 may be configured to exhaust the polycrystal silicon formed in the reaction pipe 905, when the temperature inside the reaction pipe 905 sensed by the temperature sensor 930 is an exhaustion start temperature or more.

The temperature inside the reaction pipe 905 as the level information may be changeable according to the height of the fluidized bed.

In other words, as seed silicon is growing into polycrystal silicon, the height of the fluidized bed is increasing from H61 for the fluidized bed to approach the temperature sensor 930. Accordingly, the temperature inside the reaction pipe 905 sensed by the temperature sensor 930 may increase.

As the fluidized bed is getting closer to the temperature sensor 930, the temperatures inside the reaction pipe 905 measured by the temperature sensor 930 are getting closer to the exhaustion start temperature. Once the height of the fluidized bed is the exhaustion start height (H62) or more by the continuous growth of the polycrystal silicon, the temperature inside the reaction pipe 905 sensed by the temperature sensor 930 may be the exhaustion start temperature or more.

The control unit 1000 may output a control signal to open the valve 915, when the temperature inside the reaction pipe 905 measured by the temperature sensor 930 is the exhaustion start temperature or more. As the valve 915 is open, the polycrystal silicon is exhausted outside the polycrystal silicon manufacturing apparatus via the particle outlet 16.

As the polycrystal silicon is exhausted, the height of the fluidized bed is lowered. As the fluidized bed is getting farther from the temperature sensor 930, the temperature inside the reaction pipe 905 is also lowered.

At this time, the fluidized bed is lowered and the height of the fluidized bed reaches H63. When the temperature inside the reaction pipe 905 sensed by the temperature sensor 930 reaches an exhaustion stop temperature, the particle outlet 16 may stop the exhaustion of the polycrystal silicon. In other words, the particle outlet 16 may exhaust the polycrystal silicon until the temperature inside the reaction pipe 905 sensed by the temperature sensor 930 reaches the exhaustion stop temperature.

Such the temperature sensor 930 may sense the heat transmitted via a lateral surface of the reaction pipe 905 or via a hole formed in the lateral surface of the reaction pipe 905. In FIG. 8, the temperature sensor 930 can sense the heat transmitted via the hole and the temperature sensor 930 may be installed adjacent to the window 920 inserted in the hole in this case. Different from the polycrystal silicon manufacturing apparatus of FIG. 8, the temperature sensor 930 may sense change in the temperatures of the lateral surface of the reaction pipe 905.

When the temperature sensor 930 is installed adjacent to the lateral surface of the reaction pipe 905, the distance between the temperature sensor 930 and the fluidized bed is relatively short and the temperature sensor 930 can sense temperature change generated by height change generated by the fluidized bed precisely.

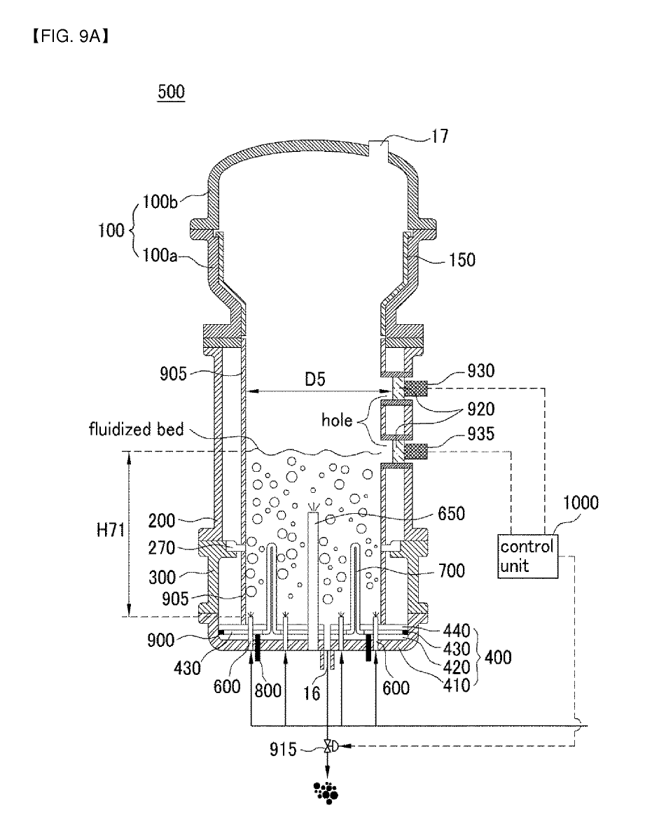

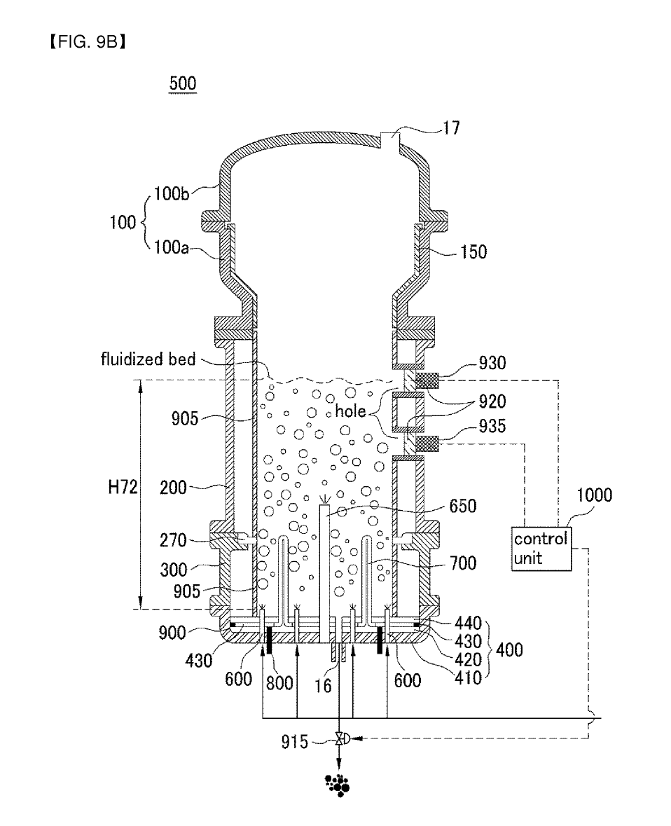

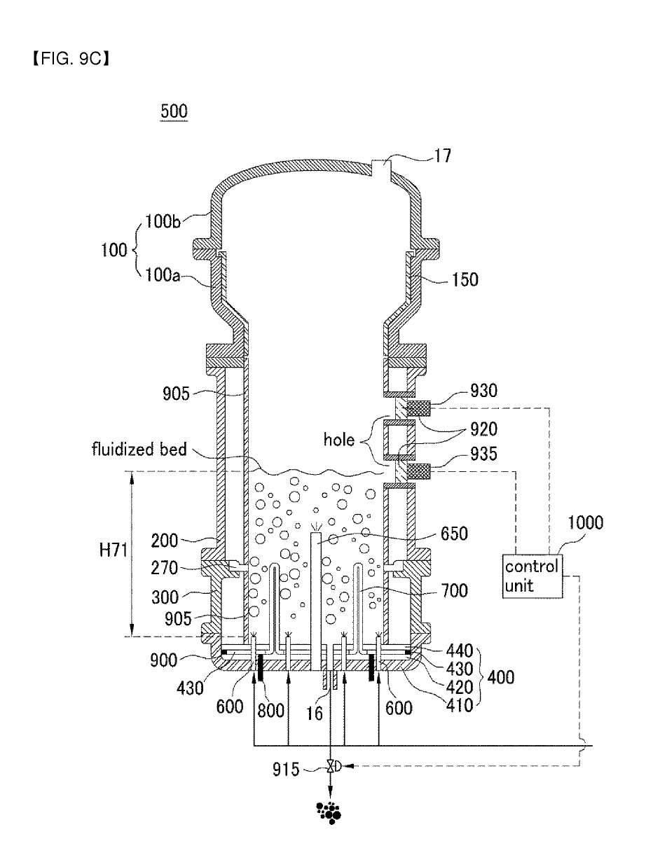

Meanwhile, as shown in FIGS. 9A to 9C, a polycrystal silicon manufacturing apparatus according to this embodiment may further include an auxiliary temperature sensor 935 installed lower than the temperature sensor 930. The window 920 may be installed between the auxiliary temperature sensor 935 and the reaction space.

At this time, a hole is formed in a lateral surface of the reaction pipe 905 to make the reaction space communicate with the outside of the polycrystal silicon manufacturing apparatus and the window 920 for protecting the auxiliary temperature sensor 935 may be inserted in the hole.

As shown in FIG. 9A, the height of the fluidized bed rises up to H71 as polycrystal silicon grows such that the fluidized bed can be positioned in front of the auxiliary temperature sensor 935. Accordingly, the temperature sensed by the auxiliary temperature sensor 935 may be an exhaustion stop temperature or more. In addition, the fluidized bed may not reach an area in front of the temperature sensor and the temperature sensed by the temperature sensor 930 can be lower than an exhaustion start temperature.

As shown in FIG. 9B, the polycrystal silicon is continuously growing and the fluidized bed can reach H72 that is an exhaustion start height. Accordingly, the fluidized bed may be positioned in front of the temperature sensor 930 and the temperature sensed by the temperature sensor may be the exhaustion start temperature or more. Hence, the temperature inside the reaction pipe 905 sensed by the temperature sensor 930 is the exhaustion start temperature or more and the particle outlet 16 starts to exhaust the polycrystal silicon.

As shown in FIG. 9C, the height of the fluidized bed is lowered to H71 by the exhaustion of the polycrystal silicon and the fluidized bed passes the front area of the auxiliary temperature sensor 935. After that, the temperatures inside the reaction pipe 905 sensed by the temperature sensor 930 and the auxiliary temperature sensor 935, respectively, are lower than the exhaustion start temperature and the exhaustion stop temperature, respectively, such that the particle outlet 16 may stop the exhaustion of the polycrystal silicon.

The control unit 1000 may output a control signal to close the valve 915, once the temperatures inside the reaction pipe 905 sensed by the temperature sensor 930 and the auxiliary temperature sensor 935, respectively, are lower than the exhaustion start temperature and the exhaustion stop temperature, respectively.

As mentioned above, the exhaustion start temperature may be identical to or different from the exhaustion stop temperature.

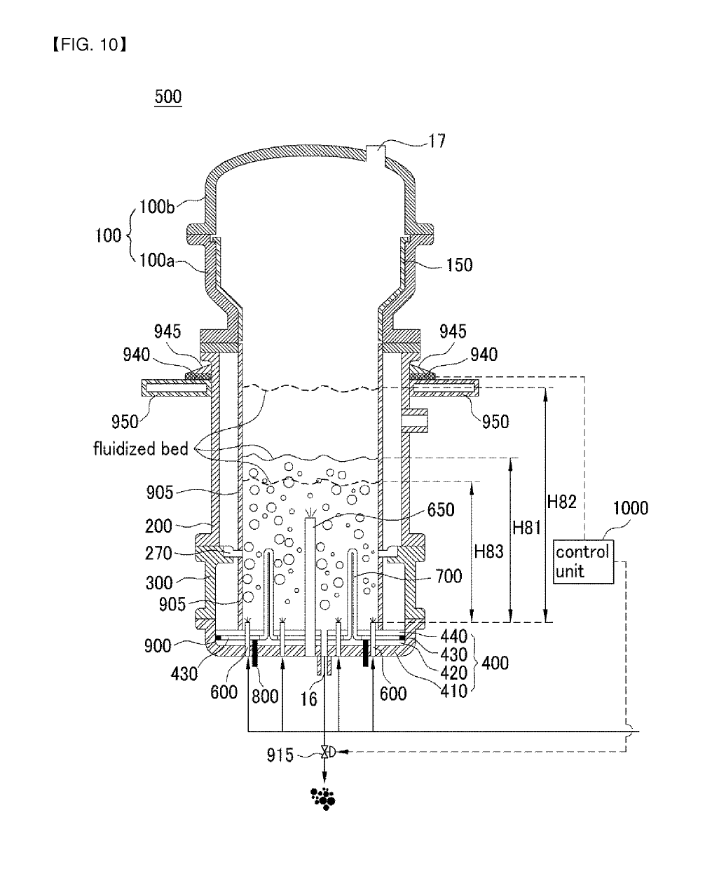

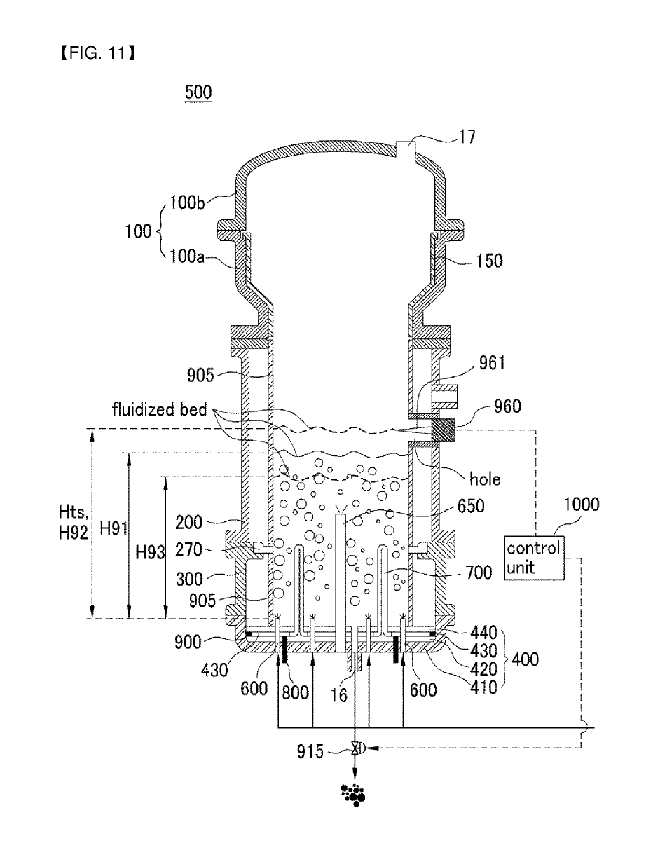

FIG. 10 is a diagram illustrating method of exhausting silicon from the polycrystal silicon manufacturing apparatus according to the embodiment, based on the weight of the apparatus.

As shown in FIG. 10, a polycrystal silicon manufacturing apparatus according to one embodiment may include a weight sensor 940. The weight sensor 940 includes a piezoelectric element (not shown) to output a sensing signal according to change in weights of the polycrystal silicon apparatus. The polycrystal silicon manufacturing apparatus according to the embodiment may include other various types of weight sensors 940, except such a piezoelectric type.

The weight sensor 940 may sense weights of the polycrystal silicon manufacturing apparatus, which are changeable according to the growth of the polycrystal silicon, as a level information. The weight of the polycrystal silicon increases in proportion to the growth of the polycrystal silicon and the weight of the operating polycrystal silicon manufacturing apparatus is changed such that the weight sensor 940 can sense the changed weight of the polycrystal silicon manufacturing apparatus.

The particle outlet 16 may be configured to exhaust the polycrystal silicon formed in the reaction pipe 905, when the weight of the polycrystal silicon manufacturing apparatus sensed by the weight sensor 940 is an exhaustion start weight or more.

As shown in FIG. 10, seed silicon is growing into polycrystal silicon and the height of the fluidized bed is increasing from H81 to increase the weight of the polycrystal silicon manufacturing apparatus. Once the height of the fluidized bed rises up to H82 that is an exhaustion start height, the weight of the polycrystal silicon manufacturing apparatus sensed by the weight sensor 940 may be the exhaustion start weight or more.

The control unit 1000 may output a control signal to open the valve 915, when the weight of the polycrystal silicon manufacturing apparatus measured by the weight sensor 940 reaches the exhaustion start weight or more. As the valve 915 is open, the polycrystal silicon is exhausted outside the polycrystal silicon manufacturing apparatus via the particle outlet 16.

As the polycrystal silicon is exhausted, the height of the fluidized bed is lowered and the weight of the polycrystal silicon manufacturing apparatus sensed by the weight sensor 940 is lowered as well. At this time, when the fluidized bed is lowered to H83 for the weight of the polycrystal silicon manufacturing apparatus to be an exhaustion stop weight, the particle outlet 16 may stop the exhaustion of the polycrystal silicon. In other words, the particle outlet 16 may exhaust the polycrystal silicon until the weight of the polycrystal silicon manufacturing apparatus sensed by the weight sensor 940 reaches the exhaustion stop weight.

As shown in FIG. 10, a support 945 projected from an outer surface of the polycrystal silicon manufacturing apparatus may be supported by a supporting member 950 installed outside the polycrystal silicon manufacturing apparatus. The weight sensor 940 may be positioned between the support 940 and the supporting member 950 such that the weight sensor 940 may sense the weight of the polycrystal silicon manufacturing apparatus.

FIG. 11 is a diagram illustrating a method of exhausting silicon from the polycrystal silicon manufacturing apparatus according to the embodiment, based on the frequency. As shown in FIG. 11, the polycrystal silicon manufacturing apparatus according to the embodiment may include a vibration sensor 960.

The vibration sensor 960 is configured to sense contact with the fluidized bed according to growth of polycrystal silicon to output a frequency as a level information.

At this time, the vibration sensor 960 can sense a contact with the fluidized bed at a preset sensing height that is the height (Hts) at which the vibration sensor 960 is installed. The vibration sensor 960 may be a piezoelectric acceleration type or a cantilever vibration type and this embodiment is not limited thereto. Various types of vibration sensors can be applied.

In FIG. 11, the sensing height is measured with respect to an end of the flowing gas supply unit 600 and that is one of examples. Various references including one surface of the third plate 430 exposed to the reaction space may be set.

The particle outlet 16 may be configured to exhaust the polycrystal silicon formed in the reaction pipe 905, when a frequency is an exhaustion start frequency or more.

The frequency as the level information may be changeable according to the height of the fluidized bed. In other words, as seed silicon is growing into polycrystal silicon, the height of the fluidized bed is increasing from H91 for the fluidized bed to approach the vibration sensor 960. Accordingly, the particle of the fluidized bed such as seed silicon and polycrystal silicon starts to contact with a needle 961 of the vibration sensor and the frequency sensed by the vibration sensor 960 rises up.

As the fluidized bed is getting closer to the vibration sensor 960, more particles contact with the vibration sensor 960 and the frequency output by the vibration sensor 960 is getting closer to an exhaustion start frequency. Once the height of the fluidized bed is the exhaustion start height (H92) or more by the continuous growth of the polycrystal silicon, the frequency output by the vibration sensor 960 may be the exhaustion start frequency or more.

The control unit 1000 may output a control signal to open the valve 915, when the frequency input from the vibration sensor 960 thereto is the exhaustion start frequency or more. As the valve 915 is open, the polycrystal silicon is exhausted outside the polycrystal silicon manufacturing apparatus via the particle outlet 16.

As the fluidized bed is getting farther from the vibration sensor 960, with the height of the fluidized being lowered by the exhaustion of the polycrystal silicon, the particles contacting with the vibration sensor 960 are reduced and the frequency output by the vibration sensor 960 is also lowered.

At this time, the fluidized bed is lowered and the height of the fluidized bed reaches H93. When the frequency output by the vibration sensor 960 reaches an exhaustion stop frequency after that, the particle outlet 16 may stop the exhaustion of the polycrystal silicon. In other words, the particle outlet 16 may exhaust the polycrystal silicon until the frequency output by the vibration sensor 960 reaches the exhaustion stop frequency.

The particles of the fluidized bed contact with the vibration sensor 960 and the vibration sensor 960 may be installed to pass through a lateral surface of the reaction pipe 905. At this time, the vibration sensor 960 may include a needle 961 configured to contact with the fluidized bed. The needle 961 may be formed of an inorganic material capable of preventing contamination of the polycrystal silicon, or a lining formed of an inorganic material may be on a surface of the needle 961. Such an inorganic material may include at least one of silicon, silica, graphite or silicon nitride.

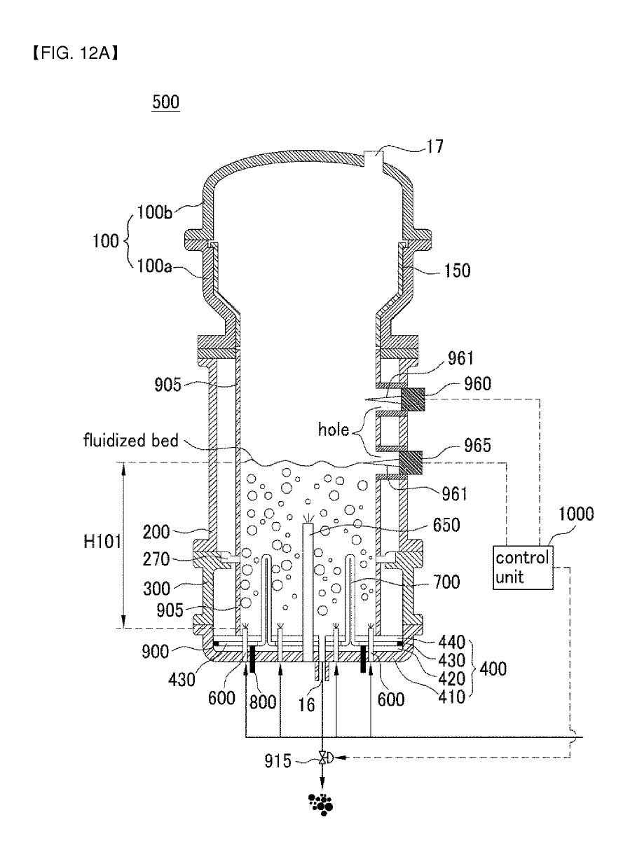

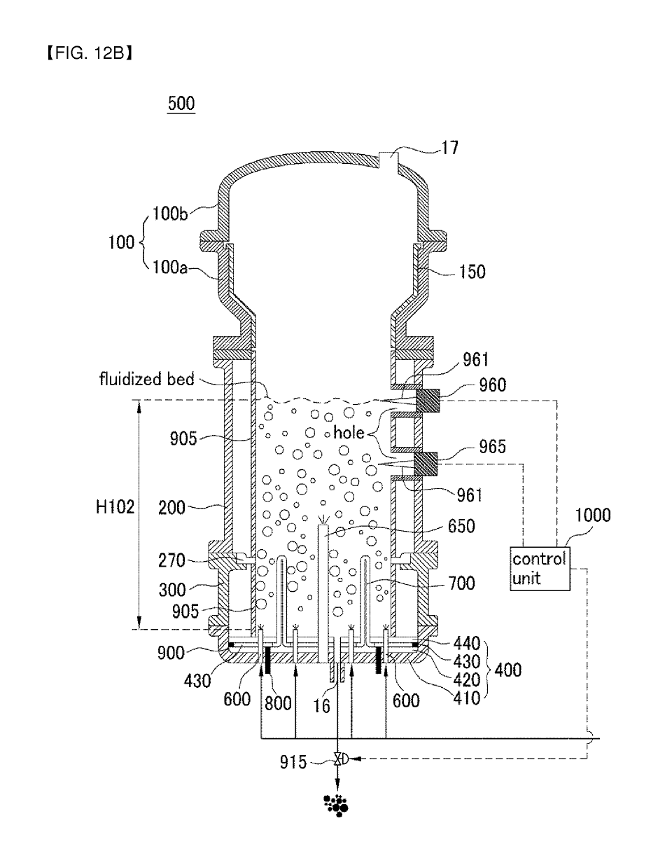

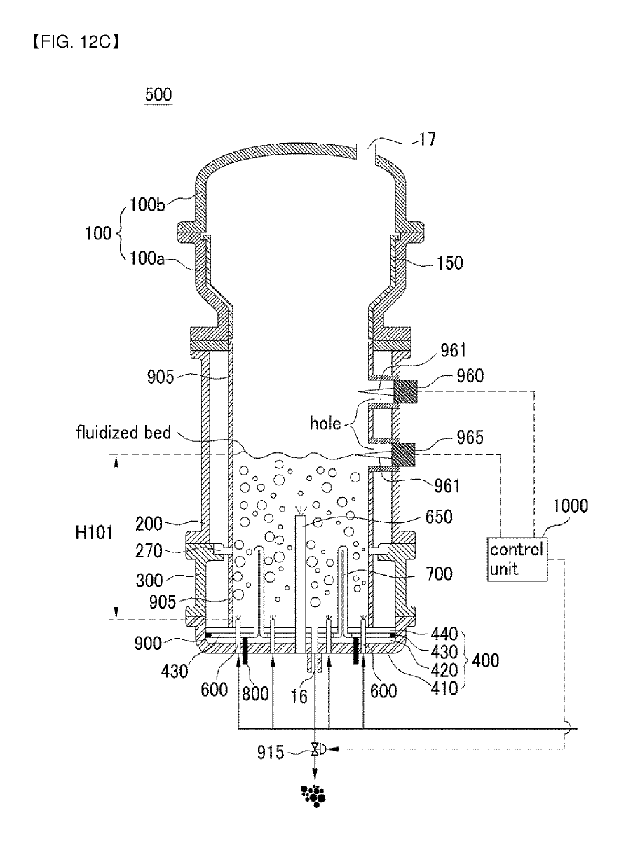

Meanwhile, as shown in FIGS. 12A to 12C, a polycrystal silicon manufacturing apparatus according to another embodiment may further include an auxiliary vibration sensor 965 installed lower than the vibration sensor 960. At this time, a hole is formed in a lateral surface of the reaction pipe 905 to make the reaction space communicate with the outside of the polycrystal silicon manufacturing apparatus and the window 920 for protecting the auxiliary vibration sensor 965 may be inserted in the hole.

As shown in FIG. 12A, the height of the fluidized bed rises up to H101 as polycrystal silicon grows such that the fluidized bed can be positioned in front of the auxiliary vibration sensor 965. Accordingly, the frequency output by the auxiliary vibration sensor 965 may be an exhaustion stop frequency or more. In addition, the fluidized bed may not reach an area in front of the vibration sensor 960 and the frequency output by the vibration sensor 960 can be lower than an exhaustion start frequency.

As shown in FIG. 12B, the polycrystal silicon is continuously growing and the fluidized bed can reach H102 that is an exhaustion start height. Accordingly, the fluidized bed may be positioned in front of the vibration sensor 960 and the frequency output by the vibration sensor 960 may be the exhaustion start frequency or more. Hence, the frequency output by the vibration sensor 960 is the exhaustion start frequency or more and the particle outlet 16 starts to exhaust the polycrystal silicon.

As shown in FIG. 12C, the height of the fluidized bed is lowered to H101 by the exhaustion of the polycrystal silicon and the fluidized bed passes in front of the auxiliary vibration sensor 965. After that, the frequency and an auxiliary frequency output by the vibration sensor 960 and the auxiliary vibration sensor 965, respectively, are lower than the exhaustion start frequency and the exhaustion stop frequency, respectively, such that the particle outlet 16 may stop the exhaustion of the polycrystal silicon.

The control unit 1000 may output a control signal to close the valve 915, once the frequencies output by the vibration sensor 960 and the auxiliary vibration sensor 965, respectively, are lower than the exhaustion start frequency and the exhaustion stop frequency, respectively.

As mentioned above, the exhaustion start frequency may be identical to or different from the exhaustion stop frequency.

When a particular feature, structure, or characteristic is described in connection with any embodiment, it is submitted that it is within the purview of one skilled in the art to affect such feature, structure, or characteristic in connection with other ones of the embodiments. Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A polycrystal silicon manufacturing apparatus comprising:
a reaction pipe configured to provide a reaction space where seed silicon grows into polycrystal silicon;
a flowing-gas supply unit configured to supply flowing gas to the seed silicon and the polycrystal silicon provided in the reaction pipe;
a sensing unit configured to output level information based on the height of a fluidized bed which is changeable according to the growth of the polycrystal silicon; and
a particle outlet configured to exhaust the polycrystal silicon formed in the reaction pipe outside, when the height of the fluidized bed corresponding to the level information is larger than an exhaustion start height of the fluidized bed corresponding to an exhaustion start level.

2. The polycrystal silicon manufacturing apparatus according to claim 1, wherein the sensing unit comprises a distance sensor configured to sense a distance to the fluidized bed, which is changeable according to the growth of the polycrystal silicon, as the level information, and
the particle outlet is configured to exhaust the polycrystal silicon formed in the reaction pipe, when the distance between the distance sensor and the fluidized bed is an exhaustion start distance or less.

3. The polycrystal silicon manufacturing apparatus according to claim 2, wherein the distance sensor is provided in opposite to the flowing gas supply unit to output a sensing signal toward the fluidized bed.

4. The polycrystal silicon manufacturing apparatus according to claim 2, wherein a window is installed between the distance sensor and the reaction space to protect the distance sensor.

5. The polycrystal silicon manufacturing apparatus according to claim 3, wherein the particle outlet is configured to exhaust the polycrystal silicon until the distance reaches an exhaustion stop distance.

6. The polycrystal silicon manufacturing apparatus according to claim 2, wherein the distance sensor is provided to output a sensing signal toward an inner surface of the reaction pipe.

7. The polycrystal silicon manufacturing apparatus according to claim 6, further comprising:
an auxiliary distance sensor installed lower than the distance sensor,
wherein the particle outlet is configured to stop the exhaustion of the polycrystal silicon, when the distances sensed by the distance sensor and the auxiliary distance sensor, respectively are larger than the exhaustion start distance and an exhaustion stop distance, respectively.

8. The polycrystal silicon manufacturing apparatus according to claim 1, wherein the sensing unit comprises a temperature sensor configured to sense a temperature inside the reaction pipe, which is changeable according to the growth of the polycrystal silicon, as the level information, and
the particle outlet is configured to exhaust the polycrystal silicon formed in the reaction pipe outside, when the temperature inside the reaction pipe sensed by the temperature sensor is an exhaustion start temperature or more.

9. The polycrystal silicon manufacturing apparatus according to claim 8, wherein a window is installed between the temperature sensor and the reaction space to protect the temperature sensor.

10. The polycrystal silicon manufacturing apparatus according to claim 8, wherein the temperature sensor senses the heat transmitted via a lateral surface of the reaction pipe or via a hole formed in the lateral surface.

11. The polycrystal silicon manufacturing apparatus according to claim 8, wherein the particle outlet is configured to exhaust the polycrystal silicon, until the temperature sensed by the temperature sensor reaches an exhaustion stop temperature.

12. The polycrystal silicon manufacturing apparatus according to claim 8, further comprising:
an auxiliary temperature sensor installed lower than the temperature sensor,
wherein the particle outlet is configured to stop the exhaustion of the polycrystal silicon, when the temperatures sensed by the temperature sensor and the auxiliary temperature sensor, respectively are lower than the exhaustion start temperature and an exhaustion stop temperature, respectively.

13. The polycrystal silicon manufacturing apparatus according to claim 1, wherein the sensing unit comprises a weight sensor configured to sense a weight of the polycrystal silicon manufacturing apparatus, which is changeable according to growth of the polycrystal silicon, as the level information, and
the particle outlet is configured to exhaust the polycrystal silicon formed in the reaction pipe outside, when the weight of the polycrystal silicon manufacturing apparatus sensed by the weight sensor is an exhaustion start weight or more.

14. The polycrystal silicon manufacturing apparatus according to claim 13, wherein the particle outlet is configured to exhaust the polycrystal silicon, until the weight sensed by the weight sensor reaches an exhaustion stop weight.

15. The polycrystal silicon manufacturing apparatus according to claim 13, wherein a support projected from an outer surface of the polycrystal silicon manufacturing apparatus is supported by a supporting member installed outside the polycrystal silicon manufacturing apparatus, and
the weight sensor is positioned between the support and the support member.

16. The polycrystal silicon manufacturing apparatus according to claim 1, wherein the sensing unit comprises a vibration sensor configured to output a frequency as the level information by sensing contact with the fluidized bed according to growth of the polycrystal silicon, and
the particle outlet is configured to exhaust the polycrystal silicon formed in the reaction pipe outside, when the frequency is an exhaustion start frequency or more.

17. The polycrystal silicon manufacturing apparatus according to claim 16, wherein the vibration sensor is installed to pass through a lateral surface of the reaction pipe.

18. The polycrystal silicon manufacturing apparatus according to claim 17, wherein the vibration sensor comprises a needle configured to contact with the fluidized bed, and
the needle is formed of an inorganic material capable of preventing contamination of the polycrystal silicon, or a lining formed of an inorganic material is on a surface of the needle.

19. The polycrystal silicon manufacturing apparatus according to claim 17, wherein the particle outlet is configured to exhaust the polycrystal silicon, until the frequency output by the vibration sensor reaches an exhaustion stop frequency.

20. The polycrystal silicon manufacturing apparatus according to claim 17, further comprising:
an auxiliary vibration sensor installed lower than the vibration sensor,
wherein the particle outlet is configured to stop the exhaustion of the polycrystal silicon, when the frequency and an auxiliary frequency output by the vibration sensor and the auxiliary vibration sensor, respectively are lower than the exhaustion start frequency and an exhaustion stop frequency, respectively.
